(19) United States
(12) Patent Application Publication
(10) Pub. No.: US 2023/0279182 A1
(43) Pub. Date: Sep. 7, 2023

(54) PROCESS FOR POLYIMIDE SYNTHESIS AND POLYIMIDES MADE THEREFROM

(71) Applicants: ZYMERGEN INC., Emeryville, CA (US); SUMITOMO CHEMICAL COMPANY, LIMITED, Tokyo (JP)

(72) Inventors: Justin KERSZULIS, San Leandro, CA (US); Abhiram KANNAN, Emeryville, CA (US); Peter Lucas POLIAK, Emeryville, CA (US); Liza LOPEZ, San Jose, CA (US); Kelby HULL, Emeryville, CA (US); Patrick HOMYAK, Oakland, CA (US); Gaurav CHACHRA, Emeryville, CA (US); Christopher Leland MCGANN, Oakland, CA (US); Arjan ZOOMBELT, San Mateo, CA (US); Koji ISHIWATA, Osaka (JP)

(21) Appl. No.: 18/040,291

(22) PCT Filed: Oct. 5, 2020
(86) PCT No.: PCT/US2020/054322

§ 371 Date: Feb. 2, 2023

Related U.S. Application Data
(60) Provisional application No. 62/706,293, filed on Aug. 7, 2020.

(51) Int. Cl. C08G 73/10

(52) U.S. Cl. CPC C08G 73/1007; C08G 73/1032

(57) ABSTRACT

The present disclosure describes methods of polyimide synthesis and polyimides made therefore. The method includes placing a tetracarboxylic compound and a solvent in a reaction vessel and adding a first amount of a diamine. The first amount of the diamine is not more than 99.5 mol % of the tetracarboxylic compound inside the reaction vessel. The method can include agitating the mixture and determining a viscosity of the mixture. The method can further include adding a second amount of the diamine. The last steps can be repeated until the viscosity increases to a target value. The target viscosity can be correlated to a peak weight-averaged molecular weight of the polyimide.

### CROSS-REFERENCE TO RELATED APPLICATION

This application claims the benefit of U.S. provisional application No. 62/706,293, filed Aug. 7, 2020, which is incorporated herein by reference in its entirety.

### FIELD OF THE DISCLOSURE

The present disclosure relates to methods for preparing polyimide resins and polyimides made therefrom by monitoring reaction conditions.

### BACKGROUND

Organic films are high in flexibility as compared to glass, difficult to break, and lightweight. Recently, study has been performed with the aim of developing a flexible display using organic film as the substrate of a flat panel display.

Generally, resins used in organic film include polyester, polyamide, polyimide, polycarbonate, polyether sulfone, acrylic, and epoxy. Of these, polyimide resin is high in heat resistance, mechanical strength, abrasion resistance, dimensional stability, chemical resistance, insulation capability, and accordingly in wide use in the electric/electronic industries.

For use as an alternative to the glass substrate in display elements, polyimide resin is required to have high transparency and low birefringence. These properties are necessary to obtain clear images. However, manufacturing methods provide inconsistencies in resins leading to variation in performance properties. Accordingly, there is a need for devising and improving processes that lead to performance consistency.

### SUMMARY

Various aspects and embodiments contemplated herein may include, but are not limited to one or more of the following.

In a first aspect, a method for preparing a polyimide includes placing a tetracarboxylic compound and a solvent in a reaction vessel. The method can include adding a first amount of a diamine, wherein the first amount is not more than 99.5 mol % of the tetracarboxylic compound to the reaction vessel to form a mixture. In one embodiment, the method can include adding not more than 99 mol %, not more than 98 mol %, not more than 97 mol %, not more than 96 mol %, or not more than 95 mol % of the tetracarboxylic compound to the reaction vessel to form a mixture. The method can further include agitating the mixture. The method can further include determining a viscosity of the mixture. The method includes adding a second amount of the diamine. The method can further include repeating the determining of the viscosity and the adding of a second amount of the diamine until the viscosity increases to a target value.

In a second aspect, the present disclosure includes a polyimide resin or a polyimide formed by the foregoing method.

In a third aspect, the present disclosure includes a polyimide material made from a diamine and a tetracarboxylic compound. The diamine can be selected from

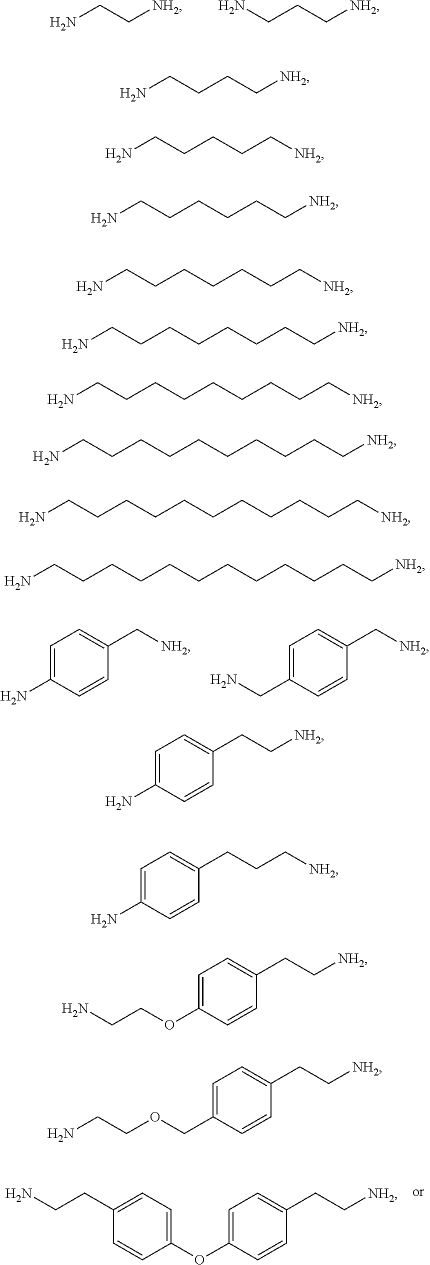

any combination thereof. The polyimide material has at least one property selected from the following property group A:
(i) a tensile strength as determined according to ASTM standard D897-08 of at least 2.4 GPa, at least 2.6 GPa, at least 2.8 GPa, at least 3.0 GPa, at least 3.2 GPa, at least 3.4 GPa, at least 3.6 GPa, at least 3.8 GPa, at least 4.0 GPa, at least 4.2 GPa, or at least 4.4 GPa;
(ii) a glass transition temperature as determined by thermomechanical analysis of at least 180° C., at least 185° C., at least 190° C., at least 195° C., at least 200° C., at least 205° C., at least 210° C., at least 215° C., at least 220° C., at least 225° C., at least 230° C., at least 235° C., at least 240° C., at least 245° C., at least 250° C., at least 255° C., at least 260° C., at least 265° C., at least 270° C., at least 275° C., at least 280° C., at least 285° C., at least 290° C., at least 295° C., at least 300° C., or at least 305° C.;
(iii) a peak molecular weight as determined by size exclusion chromatography against a polystyrene standard of at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa; or
(iv) an elongation at break of a 100 micron thick film of the polyimide film as determined by ASTM D638-14 of not more than 10%, not more than 9.5%, not more than 9%, not more than 8.5%, not more than 8%, not more than 7.5%, not more than 7%, not more than 6.5%, not more than 6.2%, not more than 6.0%, not more than 5.8%, not more than 5.6%, not more than 5.4%, not more than 5.2%, not more than 5%, or not more than 4.8%.

The polyimide material has at least one property selected from the following property group B:
(i) an optical transparency of a 100 micron (i.e., 100 micrometer in thickness) film of the polyimide material as determined by UV-Vis spectroscopy at 400 nm of at least 80%, at least 82%, at least 84%, at least 86%, at least 88%, at least 90%, at least 92%, at least 94%, at least 96%, or at least 98%;
(ii) an optical transparency of a 100 micron film of the polyimide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a 100 micron film of the polyimide material as determined by UV-Vis spectroscopy at 300 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%; or
(iv) a thickness retardation Rₜₕ of not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm;
(v) a Yellow Index according to ASTM E313 of not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4.

In a fourth and fifth aspect, the present disclosure includes an optical stack or an electronic device comprising a polyimide material as described herein.

### BRIEF DESCRIPTION OF THE DRAWINGS

The present disclosure may be better understood, and its numerous features and advantages made apparent to those skilled in the art by referencing the accompanying drawings.

FIGS. 1 and 2 include graphs displaying the change of viscosity or torque to impel the reaction mixture during addition of the second amount of diamine.

FIG. 3 includes a graph of the change of weight averaged molecular weight of a 6FDA-DAB polyimide over the course of incremental addition of diamine from a reaction mixture excessive in dianhydride.

### DETAILED DESCRIPTION

In the following specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise. Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

As described above, in a first aspect, a method for preparing a polyimide includes placing a tetracarboxylic compound and a solvent in a reaction vessel. The method can include adding a first amount of a diamine, wherein the first amount is not more than 99.5 mol % of the tetracarboxylic compound to the reaction vessel to form a mixture. In one embodiment, the method can include adding not more than 99 mol %, not more than 98 mol %, not more than 97 mol %, not more than 96 mol %, or not more than 95 mol % of the tetracarboxylic compound to the reaction vessel to form a mixture. The method can further include agitating the mixture. The method can further include determining a viscosity of the mixture. The method includes adding a second amount of the diamine. The method can further include repeating the determining of the viscosity and the adding of a second amount of the diamine until the viscosity increases to a target value. In one embodiment, the tetracarboxylic compound can be selected from:

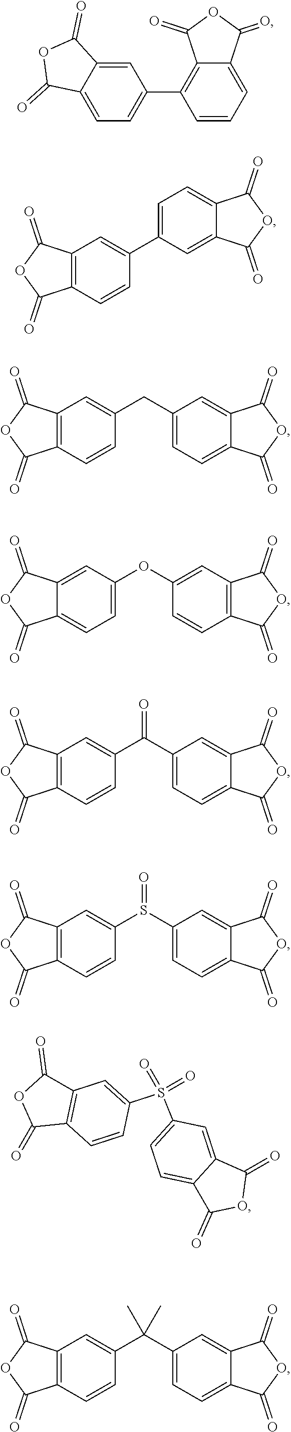

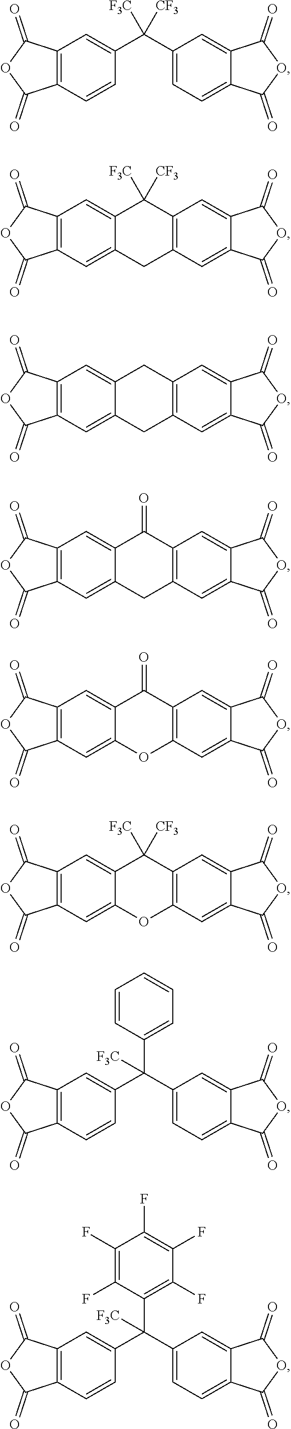

any tetracarboxylic acid thereof, or any combination thereof.

In one further embodiment, the tetracarboxylic compound can be selected from 4,4′-oxydiphthalic acid dianhydride, 3,3′,4,4′-benzophenone tetracarboxylic acid dianhydride, 2,2′,3,3′-Benzophenonetetracarboxylic dianhydride, 3,3′,4,4′-biphenyltetracarboxylic dianhydride (BPDA), 2,2′,3,3′-Biphenyltetracarboxylic dianhydride, 3,3′,4,4′-diphenylsulfone tetracarboxylic dianhydride, 2,2-bis(3,4-dicarboxyphenyl)propane dianhydride, 2,2-bis(2,3-dicarboxyphenyl)propane dianhydride, 2,2-bis(3,4-dicarboxyphenoxyphenyl)propane dianhydride, 4,4′-(hexafluoroisopropylidene)diphthalic acid dianhydride (6FDA), 1,2-bis(2,3-dicarboxyphenyl)ethane dianhydride, 1,1-bis(2,3-dicarboxyphenyl)ethane dianhydride 1,2-bis(3,4-dicarboxyphenyl)ethane dianhydride, 1,1-bis(3,4-dicarboxyphenyl)ethane dianhydride, bis(3,4-dicarboxyphenyl)methane Dianhydride, bis(2,3-dicarboxyphenyl)methane dianhydride, 4,4′-(p-phenylenedioxy)diphthalic acid dianhydride, 4,4′-(m-phenylenedioxy)diphthalate. An acid dianhydride is mentioned. Examples of monocyclic aromatic tetracarboxylic dianhydrides include 1,2,4,5-benzenetetracarboxylic dianhydride, and condensed polycyclic aromatic tetracarboxylic dianhydrides. Examples thereof include 2,3,6,7-naphthalenetetracarboxylic dianhydride. These can be used alone or in combination of two or more.

In another embodiment, the diamine can be selected from:

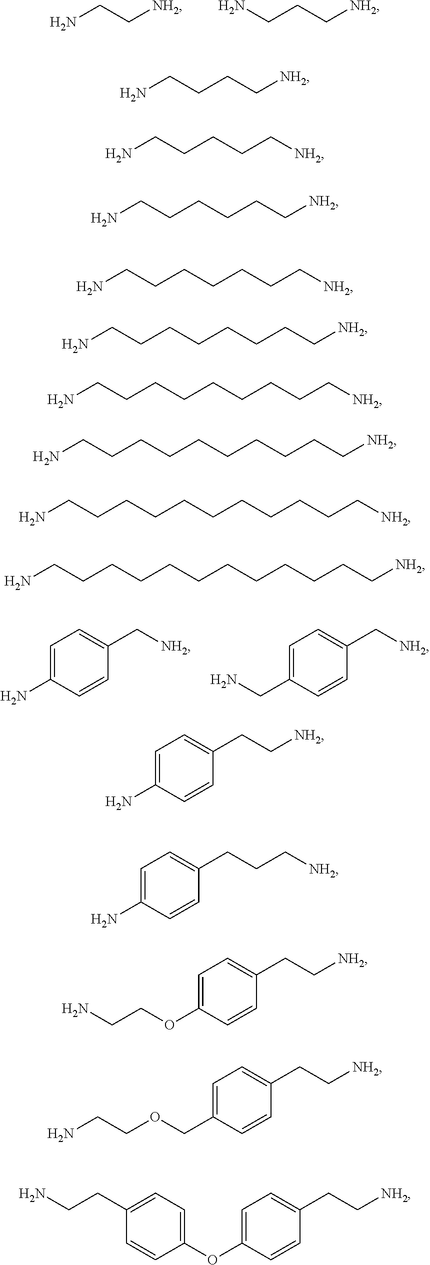

and any combination thereof.

In one embodiment, the solvent can be selected from ethylene glycol methyl ether, ethylene glycol butyl ether, 1-methoxy-2-propanol, 2-butoxyethanol, propylene glycol monomethyl ether, phenol, o-cresol, m-cresol, p-cresol, cresols, ethyl acetate, butyl acetate, ethylene glycol acetate, γ-butyrolactone, γ-valerolactone, propylene glycol acetate, ethyl lactate, acetone, methyl ethyl ketone, cyclopentanone, cyclohexanone, 2-heptanone, methyl isobutyl ketone, pentane, hexane, heptane, ethylcyclohexane, toluene, xylene, acetonitrile, tetrahydrofuran, dimethoxyethane, chloroform, chlorobenzene, N,N-dimethylacetamide, N,N-dimethylformamide, dimethyl sulfone, dimethyl sulfoxide, or any combination thereof.

In another embodiment, the method can include adding a catalyst before or after the adding of the first amount of diamine. The catalyst can be selected from N-ethylpiperidine, N-propylpiperidine, N-butylpyrrolidine, N-butylpiperidine, N-propylhexahydroazepine, azabicyclo[2.2.1]heptane, azabicyclo[3.2.1]octane, azabicyclo[2.2.2]octane, azabicyclo[3.2.2]nonane, 2-methylpyridine (2-picoline), 3-methylpyridine (3-picoline), 4-methylpyridine (4-Picoline), 2-ethylpyridine, 3-ethylpyridine, 4-ethylpyridine, 2,4-dimethylpyridine, 2,4,6-trimethylpyridine, 2,3-cyclopentenopyridine, 3,4-cyclopentenopyridine, 5,6,7,8-Tetrahydroisoquinoline, isoquinoline, or any combination thereof.

In one further embodiment, the agitating step includes heating the mixture to a temperature of at least 40° C., at least 60° C., at least 80° C., at least 100° C., at least 110° C., at least 120° C., at least 130° C., at least 140° C., at least 150° C., or at least 160° C. In one embodiment, determining the viscosity of the reaction mixture can include the viscosity being determined by a rotational viscometer, a vibrational viscometer, an oscillating viscometer, or by measuring torque of an impeller.

In one embodiment, the adding of the second amount of diamine can be done in increments of containing at least 0.001 mol %, 0.01 mol %, 0.02 mol %, 0.03 mol %, 0.04 mol %, 0.05 mol %, 0.06 mol %, 0.07 mol %, 0.08 mol %, 0.09 mol %, 0.1 mol %, 0.15 mol %, 0.2 mol %, 0.25 mol %, 0.3 mol %, 0.35 mol %, 0.4 mol %, 0.45 mol %, 0.5 mol %, or 0.55 mol % per increment, wherein the mol % is relative to the amount of the tetracarboxylic acid. For example, if the 2 mol of tetracarboxylic acid are present in the reaction vessel and an increment of 0.15 mol % is chosen, each increment of diamine addition is 2×0.0015=0.003 mol of diamine. Increments can be added either neat or in solution.

In another embodiment, the method can further include correlating the viscosity to a weight-averaged molecular weight of a polyimide. For any reaction mixture system, samples can be withdrawn at various viscosities to determine the weight-averaged or number-averaged molecular weight of the formed polyimide using size exclusion chromatography. In later repetitions of the runs, the viscosity is an indicator of the achieved molecular weight.

Once a target viscosity is achieved, the reaction can be stopped by ceasing the heating and agitating and letting the reaction mixture cool.

In one embodiment, the method further comprises adding a precipitation agent to form a precipitate. The precipitation agent can be selected from water, methanol, ethanol, propanol, butanol, pentanol, acetic acid, ammonia, or any combination thereof.

As stated above, in one aspect, a polyimide material can be made from a diamine and a tetracarboxylic compound, The diamine can be selected from

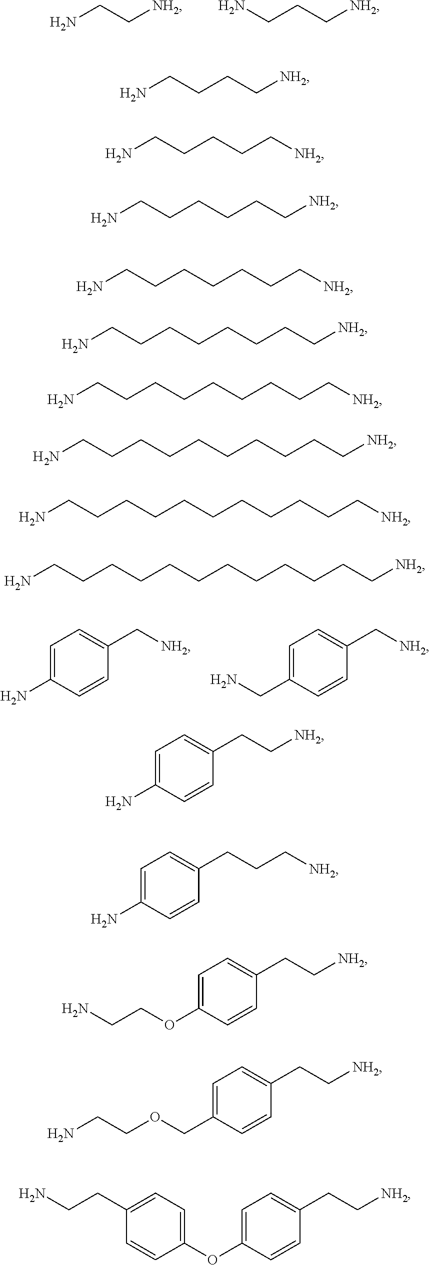

or any combination thereof. The polyimide material has at least one property selected from the following property group A:
(i) a tensile strength as determined according to ASTM standard D897-08 of at least 2.4 GPa, at least 2.6 GPa, at least 2.8 GPa, at least 3.0 GPa, at least 3.2 GPa, at least 3.4 GPa, at least 3.6 GPa, at least 3.8 GPa, at least 4.0 GPa, at least 4.2 GPa, or at least 4.4 GPa;
(ii) a glass transition temperature as determined by thermomechanical analysis of at least 180° C., at least 185° C., at least 190° C., at least 195° C., at least 200° C., at least 205° C., at least 210° C., at least 215° C., at least 220° C., at least 225° C., at least 230° C., at least 235° C., at least 240° C., at least 245° C., at least 250° C., at least 255° C., at least 260° C., at least 265° C., at least 270° C., at least 275° C., at least 280° C., at least 285° C., at least 290° C., at least 295° C., at least 300° C., or at least 305° C.;
(iii) a peak molecular weight as determined by size exclusion chromatography against a polystyrene standard of at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa; or
(iv) an elongation at break of a 100 micron thick film of the polyimide film as determined by ASTM D638-14 of not more than 10%, not more than 9.5%, not more than 9%, not more than 8.5%, not more than 8%, not more than 7.5%, not more than 7%, not more than 6.5%, not more than 6.2%, not more than 6.0%, not more than 5.8%, not more than 5.6%, not more than 5.4%, not more than 5.2%, not more than 5%, or not more than 4.8%.

The polyimide material has at least one property selected from the following property group B:
(i) an optical transparency of a 100 micron (i.e., 100 micrometer in thickness) film of the polyimide material as determined by UV-Vis spectroscopy at 400 nm of at least 80%, at least 82%, at least 84%, at least 86%, at least 88%, at least 90%, at least 92%, at least 94%, at least 96%, or at least 98%;
(ii) an optical transparency of a 100 micron film of the polyimide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a 100 micron film of the polyimide material as determined by UV-Vis spectroscopy at 300 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%; or
(iv) a thickness retardation Rₜₕ of not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm;
(v) a Yellow Index according to ASTM E313 of not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4.

In one embodiment, the polyimide material can have at least two, at least three, or at least four properties of property group A. In another embodiment, the polyimide material can have at least two, at least three, or at least four properties of property group B.

### EXPERIMENTALS

### Experiment 1

Into a 3 neck flask equipped with under nitrogen with a reflux condenser and an overhead stirrer with thermometer and torque display, 4,4′-(Hexafluoroisopropylidene)diphthalic anhydride (6-FDA) (44.42 g, 100 mmol, 1 eq), 190 mL m-cresol, and a catalytic amount of about 130 mg (˜1 mol %) of isoquinoline were combined. Then, 95 mmol (8.15 g, 95 mol %) of 1,4-diaminobutane were added. A 0.5 M solution of 1,4-diaminobutane (DAB) in m-cresol (12 mL) was placed in a dropping funnel under nitrogen atmosphere and connected to one neck of the reaction flask. The flask contents were stirred and heated to 155° C. minutes. Then, DAB from the dropping funnel was added at a rate of approximately 0.1 mL/min and the torque was monitored. After 2 hours, the reaction was stopped, allowed to cool to about 70° C. and quenched with about 650 mL of ethanol that provided a colorless powder of the polyimide.

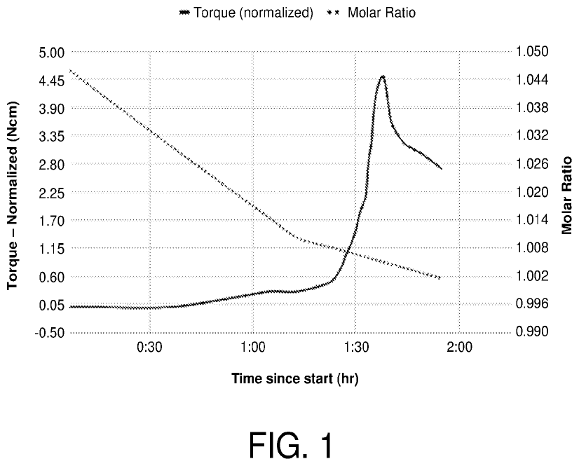

FIG. 1 displays the change of viscosity of the reaction mixture as a function of DAB addition over time from a molar ratio of 6FDA:DAB of 1.00:0.95 to about 1:1. As can be seen, a maximum can be observed after about 1:40 hours, when the molar ratio has reached about 1.005. The maximum appears to represent the actual equimolar ratio when all of anhydride has reacted off. After 1:40 hours, DAB appears to be in excess thereby reacting with the polyimide to the effect of a loss in viscosity. The loss of viscosity indicates a degradation of the polymer chains to smaller chains, likely through a reaction of excess DAB with intermittent polyamide acids as depicted here:

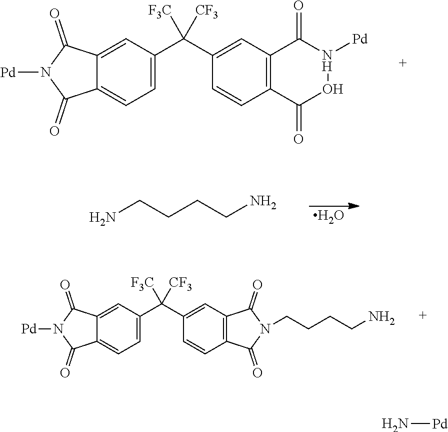

By monitoring the viscosity, the degradation of high molecular weight can be avoided, thereby providing control of the average molecular weight of the resulting polyimide.

### Experiment 2

This experiment is a repetition of Experiment 1 with smaller amounts of addition of DAB over a longer time. Into a 3 neck flask equipped with under nitrogen with a reflux condenser and an overhead stirrer with thermometer and torque display, 6-FDA (44.42 g, 100 mmol, 1 eq), 190 mL m-cresol, and 130 mg isoquinoline were combined. Then, 98 mmol (8.65 g, 98 mol %) of DAB were added. A 0.2 M solution of (DAB) in m-cresol (12 mL) was placed in a dropping funnel under nitrogen atmosphere and connected to one neck of the reaction flask. The flask contents were stirred and heated to 155° C. minutes. Then, DAB from the dropping funnel was added at a rate of approximately 0.05 mL/min and the torque was monitored.

After 3.5 hours, the reaction was stopped, allowed to cool to about 70° C. and quenched with about 650 mL of ethanol that provided a colorless powder of the polyimide.

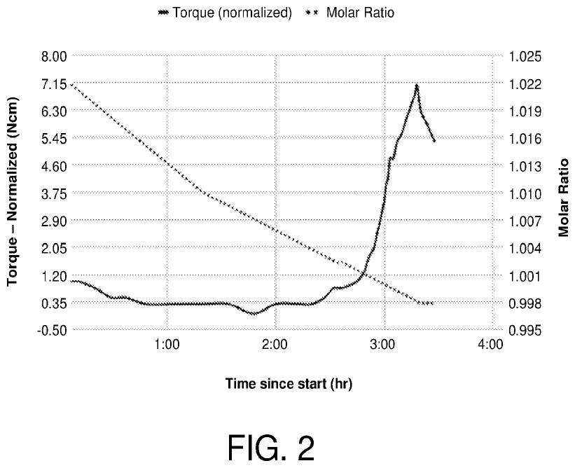

FIG. 2 displays the change of viscosity of the reaction mixture as a function of DAB addition over time from a molar ratio of 6FDA:DAB of 1.00:0.98 to about 1:1. As can be seen, a maximum can be observed after about 3:15 hours, when the molar ratio has reached about 0.998. Here again, the maximum appears to represent the actual equimolar ratio when all of anhydride has reacted off. After the peak in torque/viscosity has been reached, excess DAB degrades the polyimide chains, but since the amounts are added at smaller increments, the degradation can be stopped sooner. Similarly, during the addition of DAB prior to viscosity maximum appears to provide control or molecular chain length.

### Experiment 3

This experiment is a repetition of Experiment 2 with even smaller amounts of addition of DAB and an intermittent cease of addition. Into a 3 neck flask equipped with under nitrogen with a reflux condenser and an overhead stirrer with thermometer and torque display, 6-FDA (44.42 g, 100 mmol, 1 eq), 190 mL m-cresol, and 130 mg of isoquinoline were combined. Then, 99 mmol (8.73 g, 99 mol %) of DAB were added. A 0.1 M solution of (DAB) in m-cresol (12 mL) was placed in a dropping funnel under nitrogen atmosphere and connected to one neck of the reaction flask. The flask contents were stirred and heated to 155° C. minutes. Then, DAB from the dropping funnel was added at a rate of approximately 0.025 mL/min and the torque was monitored. The addition of DAB was stopped after addition of approximately 3 mL and kept at reaction temperature and agitation for one hour, then resumed. After 4 hours an instantaneous shot of 3 mL was added to the reaction mixture. During the course of the experiment, 50 microliter samples of the reaction mixture were taken throughout the course of the experiment, quenched and the molecular weight of the polyimides formed determined by size exclusion chromatography.

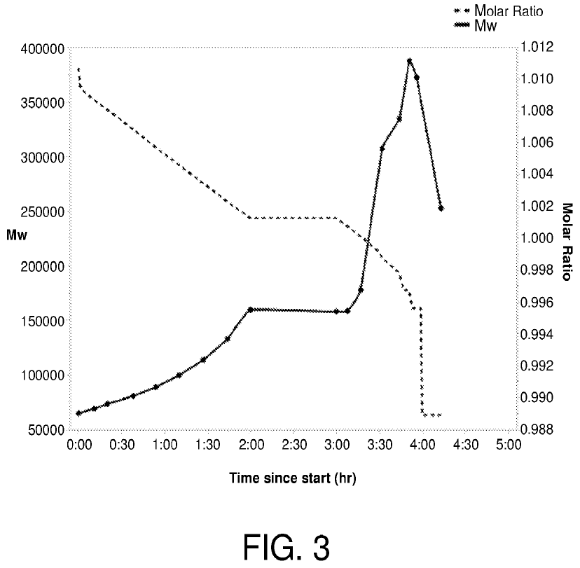

FIG. 3 displays the change of weight averaged molecular weight of the reaction as a function of DAB addition over time from a molar ratio of 6FDA:DAB of 1.00:0.99 to about 0.99:1. As can be seen, the molecular weight increases with the incremental addition of DAB, plateaus and remains constant when addition is ceased, and continues once addition is resumed. The molecular weight grows exponentially as the molar ratio reaches unity. Upon addition of excess, the molecular weight drops as conceived above through cleavage of polyamic acid chains.

1. A method for preparing a polyimide, the method comprising:
a) placing a tetracarboxylic compound and a solvent in a reaction vessel,
b) adding a first amount of a diamine, wherein the first amount is not more than 99.5 mol %, not more than 99 mol %, not more than 98 mol %, not more than 97 mol %, not more than 96 mol %, or not more than 95 mol % of the tetracarboxylic compound to the reaction vessel to form a mixture,
c) agitating the mixture,
d) determining a viscosity of the mixture,
e) adding a second amount of the diamine,
f) repeating steps d) and e) until the viscosity increases to a target value.

2. The method according to claim 1, wherein the tetracarboxylic compound is selected from: 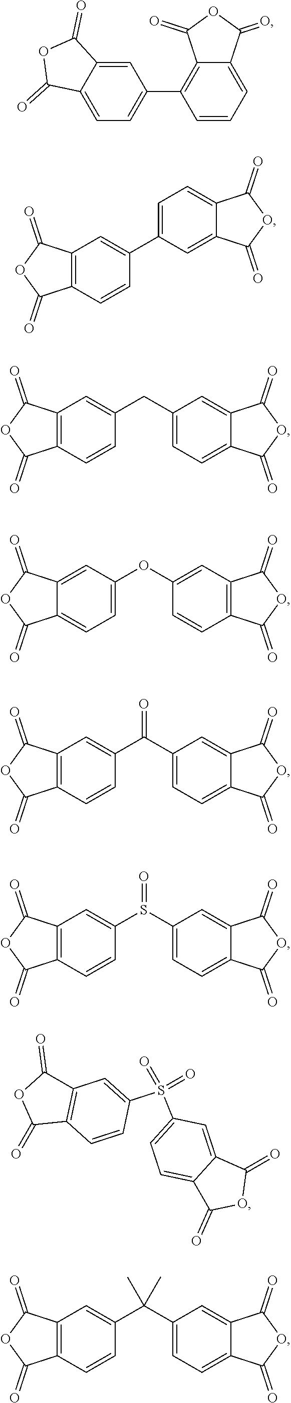 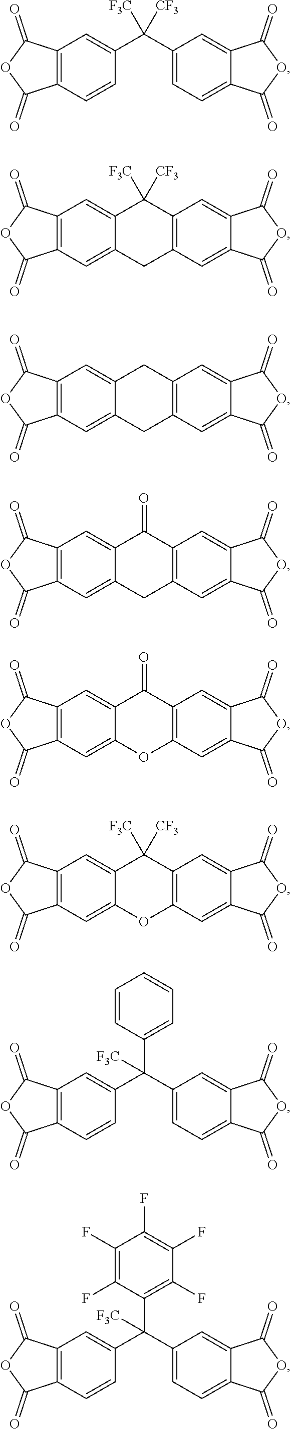
any tetracarboxylic acid thereof, or any combination thereof.

3. The method according to claim 1, wherein the diamine is selected from: 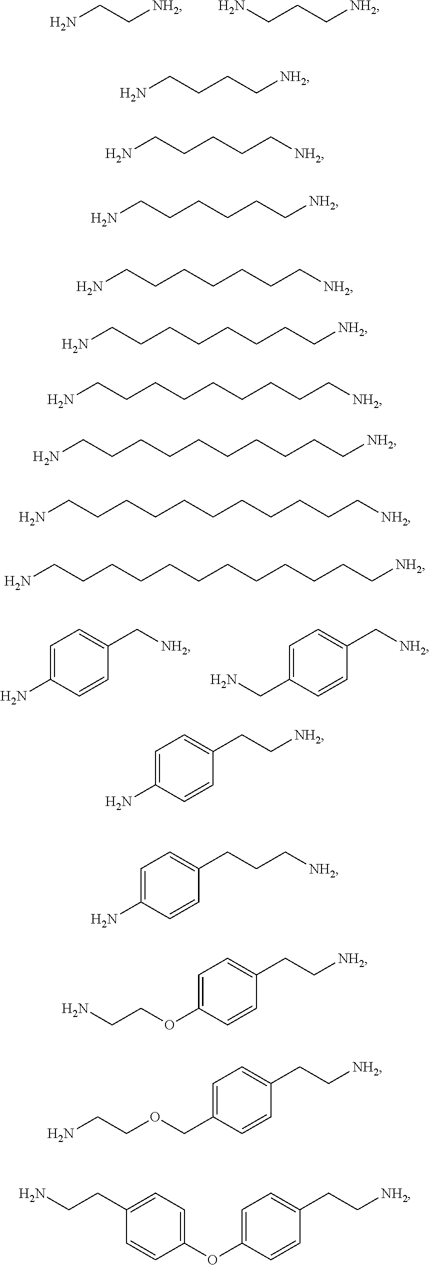
and any combination thereof.

4. The method according to claim 1, wherein the solvent is selected from ethylene glycol methyl ether, ethylene glycol butyl ether, 1-methoxy-2-propanol, 2-butoxyethanol, propylene glycol monomethyl ether, phenol, o-cresol, m-cresol, p-cresol, cresols, ethyl acetate, butyl acetate, ethylene glycol acetate, γ-butyrolactone, γ-valerolactone, propylene glycol acetate, ethyl lactate, acetone, methyl ethyl ketone, cyclopentanone, cyclohexanone, 2-heptanone, methyl isobutyl ketone, pentane, hexane, heptane, ethylcyclohexane, toluene, xylene, acetonitrile, tetrahydrofuran, dimethoxyethane, chloroform, chlorobenzene, N,N-dimethylacetamide, N,N-dimethylformamide, dimethyl sulfone, dimethyl sulfoxide, or any combination thereof.

5. The method according to claim 1, wherein step c) includes heating the mixture to a temperature of at least 40° C., at least 60° C., at least 80° C., at least 100° C., at least 110° C., at least 120° C., at least 130° C., at least 140° C., at least 150° C., or at least 160° C.

6. The method according to claim 1, wherein step b) includes adding a catalyst.

7. The method according to claim 6, wherein the catalyst is selected from N-ethylpiperidine, N-propylpiperidine, N-butylpyrrolidine, N-butylpiperidine, N-propylhexahydroazepine, azabicyclo[2.2.1]heptane, azabicyclo[3.2.1]octane, azabicyclo[2.2.2]octane, azabicyclo[3.2.2]nonane, 2-methylpyridine (2-picoline), 3-methylpyridine (3-picoline), 4-methylpyridine (4-Picoline), 2-ethylpyridine, 3-ethylpyridine, 4-ethylpyridine, 2,4-dimethylpyridine, 2,4,6-trimethylpyridine, 2,3-cyclopentenopyridine, 3,4-cyclopentenopyridine, 5,6,7,8-Tetrahydroisoquinoline, isoquinoline, or any combination thereof.

8. The method according to claim 1, wherein in step d) the viscosity is determined by a rotational viscometer, a vibrational viscometer, an oscillating viscometer, or by measuring torque of an impeller.

9. The method according to claim 1, wherein step f) includes correlating the viscosity to a weight-averaged molecular weight of a polyimide.

10. The method according to claim 1, further comprising
g) adding a precipitation agent to form a precipitate.

11. The method according to claim 10, wherein the precipitation agent is selected from water, methanol, ethanol, propanol, butanol, pentanol, acetic acid, ammonia, or any combination thereof.

12. A polyimide formed by the method according to claim 1.

13. A polyimide material made from a diamine and a tetracarboxylic compound, wherein the diamine is selected from the group consisting of: 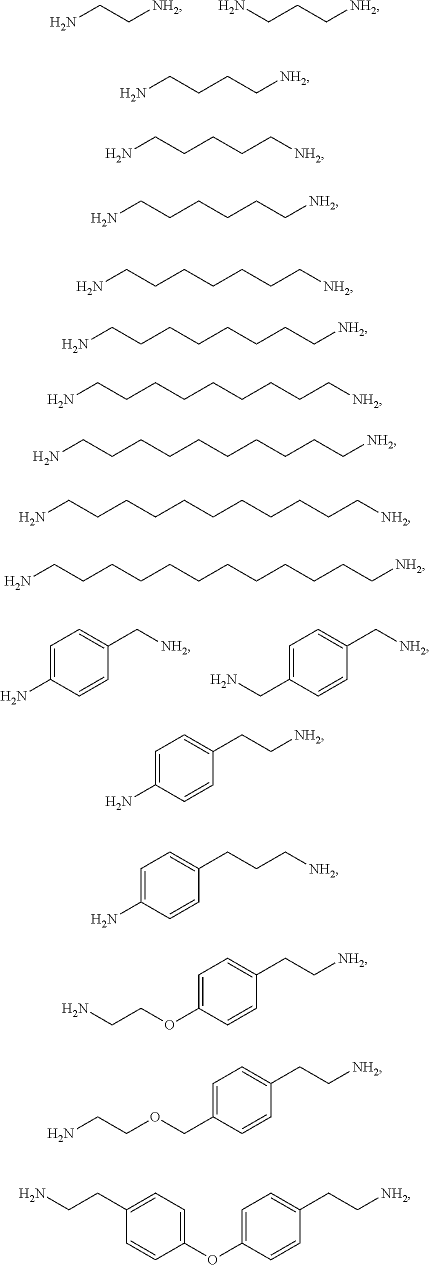
and any combination thereof;
wherein the polyimide material has at least one property selected from the following property group A and at least one property selected from the following property group B, wherein property group A comprises:
(i) a tensile strength as determined according to ASTM standard D897-08 of at least 2.4 GPa, at least 2.6 GPa, at least 2.8 GPa, at least 3.0 GPa, at least 3.2 GPa, at least 3.4 GPa, at least 3.6 GPa, at least 3.8 GPa, at least 4.0 GPa, at least 4.2 GPa, or at least 4.4 GPa;
(ii) a glass transition temperature as determined by thermomechanical analysis of at least 180° C., at least 185° C., at least 190° C., at least 195° C., at least 200° C., at least 205° C., at least 210° C., at least 215° C., at least 220° C., at least 225° C., at least 230° C., at least 235° C., at least 240° C., at least 245° C., at least 250° C., at least 255° C., at least 260° C., at least 265° C., at least 270° C., at least 275° C., at least 280° C., at least 285° C., at least 290° C., at least 295° C., at least 300° C., or at least 305° C.;
(iii) a peak molecular weight as determined by size exclusion chromatography against a polystyrene standard of at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa; or
(iv) an elongation at break of a 100 micron film of the polyimide film as determined by ASTM D638-14 of not more than 10%, not more than 9.5%, not more than 9%, not more than 8.5%, not more than 8%, not more than 7.5%, not more than 7%, not more than 6.5%, not more than 6.2%, not more than 6.0%, not more than 5.8%, not more than 5.6%, not more than 5.4%, not more than 5.2%, not more than 5%, or not more than 4.8%; and
property group B comprises:
(i) an optical transparency of a 100 micron film of the polyimide material as determined by UV-Vis spectroscopy at 400 nm of at least 80%, at least 82%, at least 84%, at least 86%, at least 88%, at least 90%, at least 92%, at least 94%, at least 96%, or at least 98%;
(ii) an optical transparency of a 100 micron film of the polyimide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a 100 micron film of the polyimide material as determined by UV-Vis spectroscopy at 300 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%;
(iv) a thickness retardation Rₜₕ of not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm; or
(v) a Yellow Index according to ASTM E313 of not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4.

14. The polyimide material according to claim 13 having at least two, at least three, or at least four properties of property group A.

15. The polyimide material according to claim 13 having at least two, at least three, or at least four properties of property group B.

16. The polyimide material according to claim 13, wherein the tetracarboxylic compound is selected from: 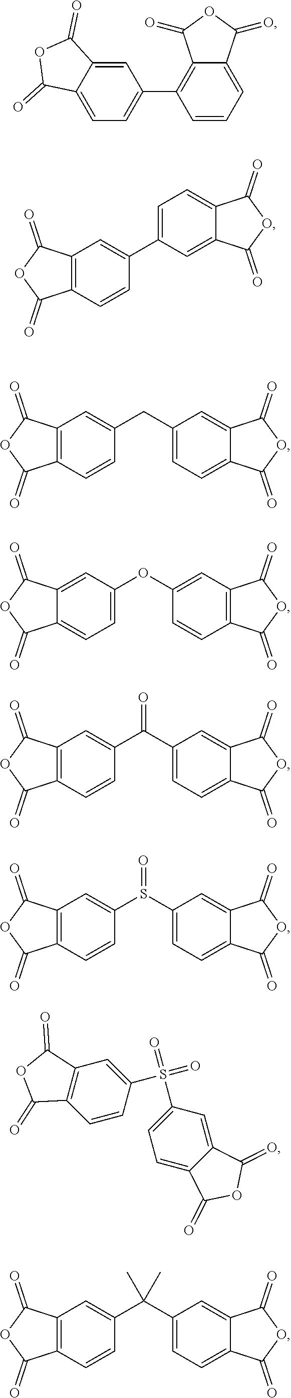 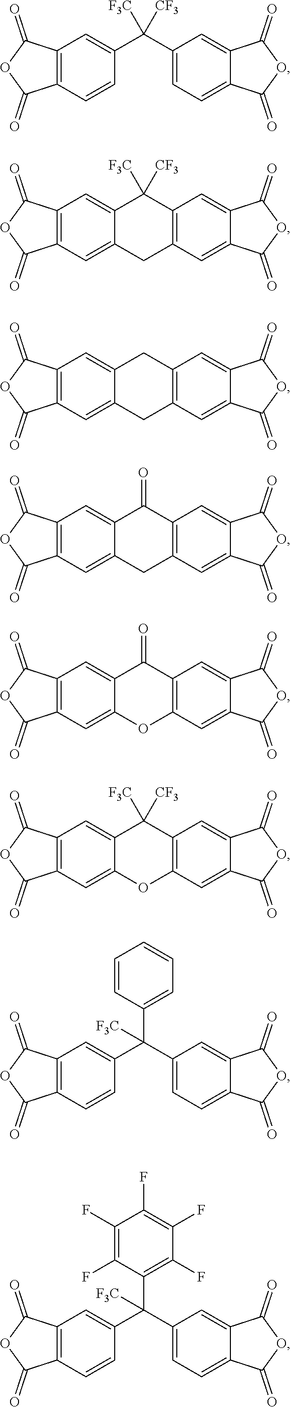
any tetracarboxylic acid thereof, or any combination thereof.

17. The polyimide material according to claim 13, wherein the diamine consists essentially of 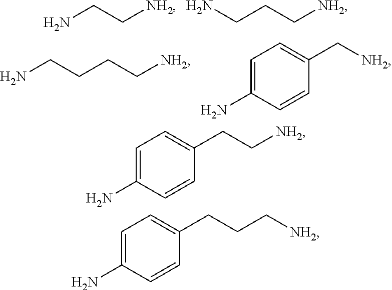
or any combination thereof.

18. The polyimide material according to claim 13, wherein the tetracarboxylic compound consists essentially of 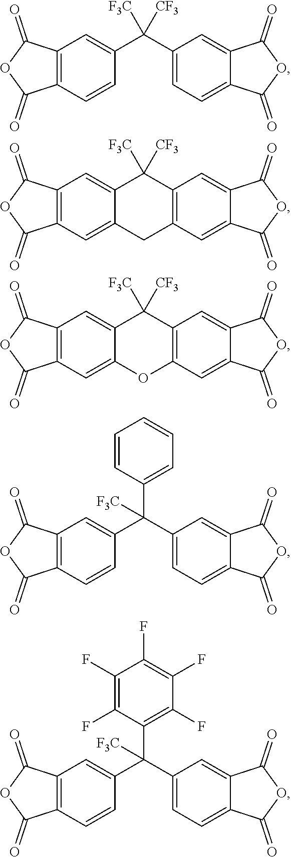
any tetracarboxylic acid thereof, or any combination thereof.

19. An optical stack comprising a polyimide material according to claim 13.

20. An electronic device comprising a polyimide material according to claim 13.
